(19) United States
(12) Patent Application Publication
(10) Pub. No.: US 2012/0120962 A1
(43) Pub. Date: May 17, 2012

(54) COMMUNICATION BETWEEN CLIENT AND SERVER USING MULTIPLE NETWORKS

(76) Inventors: Lily Ll, Scarborough (CA); Nicholas Armstrong, Kitchener (CA); Robert Robinson, Kitchener (CA); Jakub Schmidtke, Kitchener (CA); Tajinder Manku, Waterloo (CA); Paul Ward, Waterloo (CA)

(21) Appl. No.: 13/004,652

(22) Filed: Jan. 11, 2011

Related U.S. Application Data
(63) Continuation-in-part of application No. PCT/CA2009/001767, filed on Dec. 4, 2009.
(60) Provisional application No. 61/293,907, filed on Jan. 11, 2010.
(60) Provisional application No. 61/333,062, filed on May 10, 2010.
(60) Provisional application No. 61/119,966, filed on Dec. 4, 2008.

(51) Int. Cl. H04L 12/56

(52) U.S. Cl. 370/401

(57) ABSTRACT

A system is provided to facilitate communication with a client via both a first network and a second network. The system comprises a plurality of bandwidth aggregation servers, each bandwidth aggregation server configured to aggregate data packets received from the client via both the first and second networks for transmission to a destination server; and transmit data packets to the client via both the first and second networks in accordance with a scheduling algorithm, the data packets being received from a source server.

This application claims priority from U.S. provisional patent application No. 61/293,907 filed on Jan. 11, 2010; claim priority from 61/333,062 filed on May 10, 2010; is a continuation-in-part of PCT application number PCT/CA2009/001767, titled “MULTI-TRANSPORT MODE DEVICES HAVING IMPROVED DATA THROUGHPUT”, filed Dec. 4, 2009 which claims priority from U.S. provisional patent application No. 61/119,966, filed on Dec. 4, 2008; and is a continuation-in-part of PCT application number PCT/CA2010/001611, titled “USING A FIRST NETWORK TO CONTROL ACCESS TO A SECOND NETWORK”, filed on Oct. 8, 2010, which claims priority from U.S. provisional patent application No. 61/250,195, filed on Oct. 9, 2009

The present invention relates generally to a system and method for network communication and specifically to a system and method for communicating between a client and a server using multiple different networks.

### BACKGROUND

The proliferation of the Internet, portable communication devices and wireless networks has lead to the widespread use of communication devices capable of transmitting data as well as voice signals over the air. Most of the communication devices being manufactured provide at least two different wireless technologies to transmit the data; Wireless Wide Area Network (WWAN) technology and Wireless Local Area Network (WLAN) technology.

An example of a WWAN is cellular technology. Initially cellular service providers provided different data packet radio technology depending on the infrastructure they had already established. For example, cellular service providers running on a Code Division Multiple Access (CDMA) infrastructure introduced Evolution-Data Optimized (EV-DO) to provide data packet transfer. Cellular providers running on a Global System for Mobile Communications (GSM) infrastructure introduced General Packet Radio Service (GPRS) to provide data packet transfer. Currently, the GSM and CDMA infrastructures are running 3G standards. However, as the technology evolves, it appears as if most cellular service providers are moving towards the fourth generation of radio technologies, referred to as Long Term Evolution (LTE). It is expected the cellular technologies will continue to advance and evolve. However, cellular technology is still in its relative infancy and access to bandwidth is still relatively expensive and slow.

An example of a WLAN is Wi-Fi, which was developed by the Wi-Fi Alliance. Wi-Fi allows local area networks (LANs) to be deployed without wires for client devices, typically reducing the costs of network deployment and expansion. Spaces where cables cannot be run, such as outdoor areas and historical buildings, can host WLANs. Therefore, portable devices such as notebook computers, video game consoles, mobile phones and personal digital assistants can connect to the Internet when within range of a WLAN connected to the Internet. Using Wi-Fi typically provides relatively inexpensive access to bandwidth. However, Wi-Fi networks have limited range.

As both WLAN and WWAN technologies develop, it is becoming accepted that the technologies can be used to complement each other. For example, while WLAN is relatively cheap to implement, WWAN technologies are still relatively expensive. While WLAN has limited range, WWAN technologies offer a much broader range.

Accordingly, devices that offer both WLAN and WWAN technologies are currently sought after. These devices allow a user to transmit data using either technology depending on user preferences as well as network availability.

However, even the most recent WLAN protocol and newly introduced WWAN technologies offer only a portion of the bandwidth available via connections such as Ethernet. Accordingly, it is desirable to improve the throughput of mobile computing devices.

### SUMMARY

Accordingly, a network infrastructure is described that facilitates a device transmitting and receiving data using different data transmission technologies.

In accordance with an aspect of the present invention there is provided a system configured to communicate with a client via both a first network and a second network, the system comprising: a plurality of bandwidth aggregation servers, each bandwidth aggregation server configured to: aggregate data packets received from the client via both the first and second networks for transmission to a destination server; and transmit data packets to the client via both the first and second networks in accordance with a scheduling algorithm, the data packets being received from a source server; a location server configured to: receive and store access information relating to the plurality of bandwidth aggregation server; receive a request for the client to access one of the bandwidth aggregation servers; determine a target bandwidth aggregation server based on a plurality of predetermined parameters; and provide the client with an identify of the target bandwidth aggregation server.

### BRIEF DESCRIPTION OF THE DRAWINGS

Embodiments of the present invention will now be described by way of example only with reference to the following drawings in which:

FIG. 1 is a block diagram illustrating a network infrastructure in accordance with an embodiment of the present invention.

FIG. 2 is a flow chart illustrating steps for a client to connect with a mobility and aggregation server; and

FIG. 3 is a flow chart illustrating steps for the client to connect with a Wi-Fi network.

### DETAILED DESCRIPTION OF THE PREFERRED EMBODIMENTS

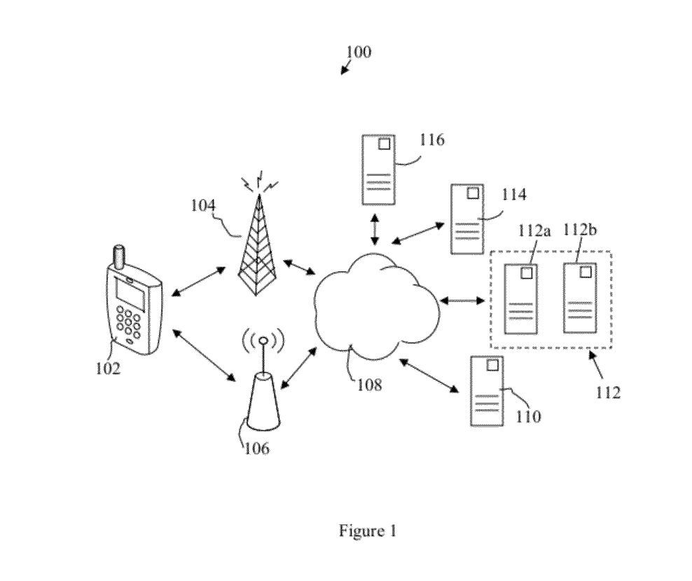

For convenience, like numerals in the description refer to like structures in the drawings. Referring to FIG. 1, a diagram illustrating a network infrastructure is illustrated generally by numeral 100. The network infrastructure 100 comprises a client 102, a first access point 104, a second access point 106, a network 108, a locator server 110, a plurality of mobility and aggregation servers (MAS) 112, one or more enrolment servers 114 and a web server 116.

In the present embodiment, the client 102 is a device capable of communicating with the network 108 via both the first access point 104 and the second access point 106. Accordingly, the client 102 can be a mobile device such as a portable computer, smartphone or a personal digital assistant (PDA), such as the iPhone® by Apple, Inc. or the Blackberry® by Research in Motion Limited, for example. As will be appreciated by a person of ordinary skill in the art, the client 102 may also be a “static” device, such as a router or desktop computer that is less likely to be moved from place to place.

The first access point 104 is a 3G base station. The second access point 106 is a Wi-Fi access point. Both the 3G base station 104 and the Wi-Fi access point 106 have their own Internet Protocol (IP) address. The locator server 110 is a service that is configured to provide the client 102 with the location of the MAS 112. The MAS 112 is a multi-homed server comprising two, or more, IP addresses. The MAS 112 is configured to provide Wi-Fi authentication services and bandwidth aggregation services. Accordingly, the MAS includes a credential server 112a and bandwidth aggregation server 112b. The enrolment server 114 is configured to enrol clients 102 for services provided by the MAS 112. The web server 116 is a remote computing device from which the client 102 is requesting information.

In the present embodiment, the locator server 110, the MAS 112, the enrolment server 114 and the web server 116 are described as being on separate machines for ease of explanation. However, various combinations may operate on the same physical machine, as will be appreciated by a person of ordinary skill in the art.

Data is segmented into data packets for transmission. Accordingly, the client 102 transmits data as a plurality of data packets to the web server 116. Client routing software is executed on the client 102 for routing the data packets. The client routing software can be loaded onto the client 102 in a number of different ways. For example, the client routing software may be factory installed on the client 102, so it is available as soon as the client 102 is activated. Alternatively, the client routing software may be actively downloaded and installed by a user of the client 102. Yet alternatively, the client routing software may be pushed to the client 102 upon the user requesting access to the MAS 112. Yet alternatively, the client routing software may be pushed to the client 102 by a third party, such as a service provider. For the purpose of the present description, the service provider is a company that provides the network access to the client 102.

The data packets can be routed over a Wi-Fi network via the Wi-Fi access point 106. The data packets can also be routed over a 3G network via the 3G base station 104. Thus, the available bandwidth for transmitting data from the client 102 is increased.

Similarly, the web server 116 transmits data to the client 102 via the MAS 112. Server routing software executing on the MAS 112 routes the data packets to the client over the 3G network and the Wi-Fi network. The client routing software executing at the client 102 combines the data packets received from the MAS 112 via both the Wi-Fi network and the 3G network. Thus, the available bandwidth for receiving data at the client 102 is increased.

Each client 102 is enrolled with the MAS 112 via the enrolment server 114. This can be achieved a number of different ways. In one example, the user navigates to a web page associated with the enrolment server 114 and enters any required information. The web page may be accessible by the user navigating to a predefined website. Once the enrolment server 114 verifies the required information received from the client 102, MAS authentication credentials, such as a user name, password, digital certificate, or any combination thereof, is transmitted to the client 102. Alternatively, an address for the website may be obtained by the client routing software. That is, the client routing software can communicate with the locator server 110 to determine the location of the enrolment server 114. The enrolment server 114 may be selected based on a number of different parameters, such as the service provider, for example. Thus, each service provider could be provisioned with its own enrolment server 114.

In another example, the MAS authentication credentials may be factory installed on the client 102, so it is available as soon as the client 102 is activated.

In yet another example, the MAS authentication credentials may be obtained from the enrolment server 114 by the third party, on behalf of the client 102, and pushed to the client 102.

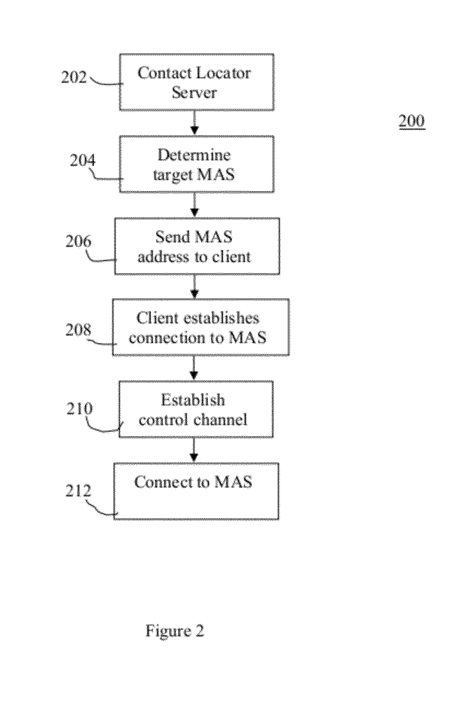

Referring to FIG. 2, a flow chart illustrating the steps taken by the client 102 to establish a connection with the MAS 112 is shown generally by numeral 200. The flow chart illustrates operation of the client 102 after it has been enrolled via the enrolment server 114 and the client routing software has been loaded.

At step 202, the client routing software contacts the locator server 110 to determine to which MAS 112 the client 102 will connect. In the present example, the client 102 sends a MAS request to the locator server 110 via the 3G base-station 104. The MAS request is describes as being sent via the 3G base-station 104, because the 3G network is generally more widely available than the Wi-Fi network. However, it will be appreciated that the MAS request could also be sent via the Wi-Fi base-station 106, if the client 102 is able to connect to it. The MAS request includes information such as the service requested, the service version, the IP address of the client 102, the physical location of the client 102 and the like.

The locator server 110 is in communication with a plurality of the MASs 112 and maintains relevant information. For example, the locator server 110 maintains information such the physical location of each MAS 112, whether each MAS 112 is active or inactive, which service provider the MAS 112 serves, the load being handled by each MAS, the available capacity of the MAS and the like. At step 204, the locator server 110 determines, based on one or more pieces of information, the identity of a target MAS 112 and at step 206 the IP addresses associated with the target MAS 112 is sent to the client.

At step 208, the client 102 communicates with the MAS 112 to establish a connection. Similar to the communication with the locator server 110, the communication is made via the 3G base-station 104, although it need not necessarily be the case. The client 102 authenticates itself using the MAS authentication credentials it received from the enrolment server 114 and provides the MAS 112 with an identifier, such as its IP address.

At step 210, the MAS 112 establishes a tunnelling control channel with the client 112. The tunnel control channel can be established over the 3G network, the Wi-Fi network or both. In the present example, the Wi-Fi network is not yet establish so the tunnelling control channel is initially established over the 3G network. A private socket layer (PSL) is used to facilitate the tunnelling control channel. The control channel sets up policy and provides a medium through which the client routing software on the client 102 and the server routing software on the MAS 112 can communicate. The MAS 112 can use the control channel to provide information to the client 102 or to request information from the client 102. Similarly, the client 102 can use the control channel to provide information to the MAS 112 or to request information from the MAS 112.

At step 212, the connection between the MAS 112 and the client 102 is established and the client uses one of the addresses associated with the MAS 112 to communicate with the MAS 112 via the 3G network.

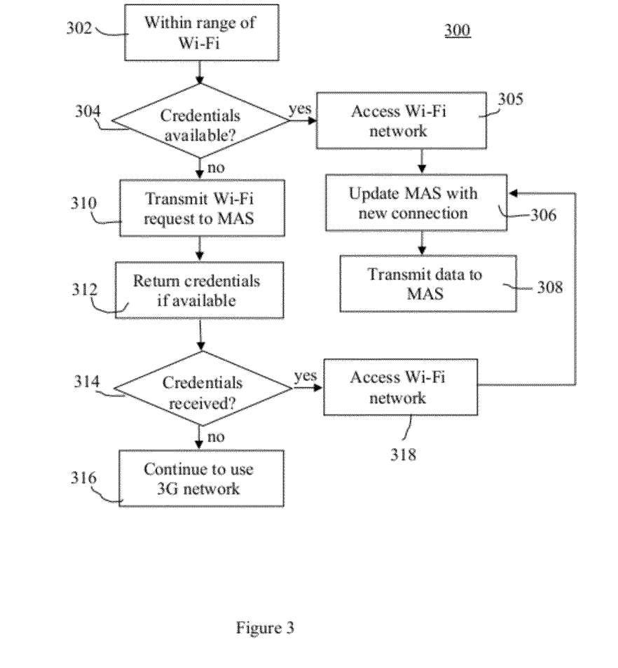

Referring to FIG. 3, a flow chart illustrating the steps taken by the client 102 to connect to a Wi-Fi network is shown generally by numeral 300. At step 302, the client 102 determines that it is within range of the Wi-Fi access point 106. At step 304, the client 102 determines if it has the Wi-Fi credentials necessary to access the Wi-Fi access point 106. This may include pre-programmed Wi-Fi credentials or the user may be prompted to provide Wi-Fi credentials.

If the client 102 has the necessary Wi-Fi credentials to access the Wi-Fi access point 106, the client 102 continues at step 305 and accesses the Wi-Fi access point 106 using the Wi-Fi credentials. The client continues to step 306 and communicates with the MAS 112 via the Wi-Fi access point 106 using a different one of the IP addresses associated with the MAS 112. The client 102 informs the MAS 112 of the new connection via the control channel. Alternatively, the since the MAS 112 starts receiving data packets at the different IP address, it can determine that a second network has been introduced. Since, the client 102 is able to send and receive data packets via both the Wi-Fi access point 106 and the 3G base-station 104, the bandwidth available to the client 102 has increased. The MAS 112 can receive data packets from the client 102 via the 3G network and the Wi-Fi network, aggregate the data packets and transmit them to the their destination.

At step 308, the client 102 transmits data to the MAS via both the 3G base-station 104 and the Wi-Fi access point 106. The client routing software include rules used to determine what type of data is transmitted across which network. Further, the client routing software includes a scheduling algorithm for scheduled packets to be transmitted via the 3G base-station 104 and the Wi-Fi access point 106. Parameters of the scheduling algorithm can be predefined or selected by the user. Further, the parameters of the scheduling algorithm can be dynamically modified by the MAS 112 via the control channel. For example, the MAS 112 can monitor traffic conditions on both the 3G network and the Wi-Fi network and provide Quality of Service (QoS) accordingly. Further, the MAS 112 can query the client 102 for transmission parameters and use these parameters to assist providing QoS. Examples of transmission parameters include parameters such as signal strength, signal to noise ratio, transmit power, receive power, base-station identification and the like. Further, examples of adjusting the scheduling can be found in Applicant's co-pending PCT application number PCT/CA2009/001767, titled “MULTI-TRANSPORT MODE DEVICES HAVING IMPROVED DATA THROUGHPUT”, filed Dec. 4, 2009, which is incorporated by reference herein.

Further, the MAS 112 can be used to enforce service provider preferences. For example, it may be desirable to rely on one of the Wi-Fi network or the 3G network at a particular time of day. Therefore, the MAS 112 can use the control channel to instruct the client 102 to schedule more, or all, data packets on a selected one of the 3G network or the Wi-Fi network at a scheduled time of day.

Network address translation NAT is used to route traffic bound for the client 102 to the MAS 112. Therefore, the IP address for the client 102 seen by other elements in the network is the same as if traditional network communication was being used. The MAS 112 receives the data packets destined for the client 112 and schedules them over the 3G network and the Wi-Fi network.

Returning to step 304, if the client 102 does not have the necessary Wi-Fi credentials to access the Wi-Fi access point 106, the client 102 continues at step 310. At step 310, the client 102 transmits a Wi-Fi access request to the MAS 112 via the control channel. The Wi-Fi request includes information identifying the Wi-Fi access point 106 to which the client 102 is attempting to access. The identifying information may be a hardware identifier, such as a service set identifier (SSID) associated with the Wi-Fi access point 106. Alternatively, the identifying information may be a software identifier, such as name of a service operating the Wi-Fi access point 106. For example, if the Wi-Fi access point 106 is set up as a hotspot, the software identifier indentifies that hotspot operator.

At step 312, the MAS 112 uses the credential service 112a to determine if the Wi-Fi credentials for the identified Wi-Fi access point 106 are available. If the Wi-Fi credentials are not available, then a corresponding message is returned to the client 102 via the control channel. If the Wi-Fi credentials are available, then the Wi-Fi credentials are returned to the client 102 via the control channel. More details relating to obtaining Wi-Fi credentials can be found in Applicant's co-pending of PCT application number PCT/CA2010/001611, titled “USING A FIRST NETWORK TO CONTROL ACCESS TO A SECOND NETWORK”, filed Oct. 8, 2010, which is incorporated by reference herein.

At step 314, the client 102 determines whether the Wi-Fi credentials were received from the MAS 112. If the Wi-Fi credentials were not received then, at step 316, the client 102 continues to transmit data using the 3G network. If the Wi-Fi credentials were available then, at step 318, the client 102 uses the received Wi-Fi credentials to access the Wi-Fi access point 106. The client then continues at step 306 and establishes a connection with the MAS 112 via the Wi-Fi access point 106.

Accordingly, it will be appreciated that the network infrastructure 100 described above provides the client 102 with an increase in available bandwidth to access the network 108.

Further, the network infrastructure 100 described above allows the client 102 to communicate with the network 108 without terminating an existing session. That is, the client 102 registers both the Wi-Fi network and the 3G network with the MAS 112. If one of the networks fails, the data packets can automatically be routed via the other network, without disrupting any sessions that may have been established. Thus, even if all data packets are being scheduled though the Wi-Fi network and the Wi-Fi network fails, the data packets would simply be routed through the 3G network, and vice versa. This is particularly advantageous for sessions that would required re-initialization if broken. For example, if the client 102 is streaming media from the web server 116 and the session is terminated, in many instances the session would need to be re-established and the streaming media would need to be restarted. However, using the network infrastructure described above, the session would not terminate and there would be no need to re-establish the session.

Accordingly, a system designer can take advantage of this feature by assigning the 3G network as a primary network and the Wi-Fi network as a secondary network, or vice versa. The data packets can then be communicated, either primarily or exclusively, using the primary network. In event the primary network fails, the data packets can be routed using the secondary network, without terminating any existing session.

Although the network infrastructure is described above with reference to specific embodiments, variations will be apparent to a person of ordinary in the art. For example, in an alternate embodiment the credential server 112a and bandwidth aggregation server 112b may be implemented separately, rather than in a single MAS 112 as described above. Such a configuration allows the credential servers 112a to be organized differently. For example, some credential servers 112a can be arranged to provide credential information for particular hotspot providers. Other credential servers 112a can be arranged to provide credential information for particular geographic locations. Still other credential servers 112a can be arranged to provide credential information for particular service providers.

In this embodiment the credential server 112a and the bandwidth aggregation server 112b report separately to the locator server 110. Thus, the locator server 110 can be used by the client 102 to locate the enrolment server 114, the credential server 112a and the bandwidth aggregation server 112b. Alternatively, the locator server 110 can be used by the aggregation server 112b to locate the credential server 112a on behalf of the client 102.

In yet an alternate embodiment, a hybrid of the two embodiments described above is provided. That is, the credential server 112a is physically co-located with the bandwidth aggregation server 112b at the MAS 112. However, supplemental credential servers are available to the MAS via the locator server 110.

Although the description makes specific reference to Wi-Fi and 3G, a person of ordinary skill will appreciate that other WLAN and WWAN technologies can likewise be implemented. Further, wired technologies such as Digital Subscriber Loop (DSL) and cable can also be used.

Yet further, although the description makes specific reference to wireless technologies, wired technologies can likewise be implemented. For example, clients 102 that are static devices may include a WWAN and a wired-LAN. As another example, it is possible that the client 102 lacks a WLAN connection but is tethered to another device to has either a WLAN or wired-LAN connection. For example a client 102 with only a WWAN transceiver can be tethered, via Bluetooth™ for example, to a laptop computer to obtain a WLAN or wired-LAN connection. As another example, a client 102 with only a WLAN connection can be tethered, via Bluetooth™ for example, to a cellular telephone to obtain the WWAN connection.

Using the foregoing specification, the invention may be implemented as a machine, process or article of manufacture by using standard programming and/or engineering techniques to produce programming software, firmware, hardware or any combination thereof.

Any resulting program(s), having computer-readable instructions, may be stored within one or more computer-usable media such as memory devices or transmitting devices, thereby making a computer program product or article of manufacture according to the invention. As such, the terms “software” and “application” as used herein are intended to encompass a computer program existent as instructions on any computer-readable medium such as on any memory device or in any transmitting device, that are to be executed by a processor.

Examples of memory devices include, hard disk drives, diskettes, optical disks, magnetic tape, semiconductor memories such as FLASH, RAM, ROM, PROMS, and the like. Examples of networks include, but are not limited to, the Internet, intranets, telephone/modem-based network communication, hard-wired/cabled communication network, cellular communication, radio wave communication, satellite communication, and other stationary or mobile network systems/communication links. The client device 102 does not need to be mobile and the first and second access points 104 and 106 do not need to provide a wireless connection to the network.

A machine embodying the invention may involve one or more processing systems including, for example, CPU, memory/storage devices, communication links, communication/transmitting devices, servers, I/O devices, or any subcomponents or individual parts of one or more processing systems, including software, firmware, hardware, or any combination or subcombination thereof, which embody the invention as set forth in the claims.

Using the description provided herein, those skilled in the art will be readily able to combine software created as described with appropriate general purpose or special purpose computer hardware to create a computer system and/or computer subcomponents embodying the invention, and to create a computer system and/or computer subcomponents for carrying out the method of the invention.

Although preferred embodiments of the invention have been described herein, it will be understood by those skilled in the art that variations may be made thereto without departing from the scope of the appended claims.

What is claimed is:

1. A system configured to communicate with a client via both a first network and a second network, the system comprising:
a plurality of bandwidth aggregation servers, each bandwidth aggregation server configured to:
aggregate data packets received from the client via both the first and second networks for transmission to a destination server; and
transmit data packets to the client via both the first and second networks in accordance with a scheduling algorithm, the data packets being received from a source server;
a location server configured to:
receive and store access information relating to the plurality of bandwidth aggregation server;
receive a request for the client to access one of the bandwidth aggregation servers;
determine a target bandwidth aggregation server based on a plurality of predetermined parameters; and
provide the client with an identify of the target bandwidth aggregation server.

2. The system of claim 1, further comprising one or more credential servers configured to receive a request for the client capable of accessing one of the first network or second network and provide the client with network credentials for accessing the other of the first network or the second network.

3. The system of claim 2, wherein the location server is further configured to identify a target one of the one or more credential servers to provide the network credentials.

4. The system of claim 3, wherein each of the credential servers includes all available network credentials.

5. The system of claim 4, wherein each of the credential servers is located at a mobility and aggregation server (MAS) along with a corresponding bandwidth aggregation server.

6. The system of claim 3, wherein each of the credential servers includes a subset of available network credentials.

7. The system of claim 3, further comprising an enrolment server configured to provide the client with bandwidth aggregation server access credentials and the client is only able to access the target bandwidth aggregation server upon verification of the bandwidth aggregation server access credentials.

8. The system of claim 3, wherein the bandwidth aggregation server is further configured to establish a control channel with the client, the control channel for communication control information between the client and the bandwidth aggregation server.

9. The system of claim 8, wherein the control information includes the network credentials.

10. The system of claim 8, wherein the control information includes parameters affecting the transmission of data packets across either or both of the first network or the second network.

11. The system of claim 8, wherein the control information includes scheduling information relating to scheduling the transmission of data packets across either or both of the first network or the second network.

12. A client device configured to communicate with a bandwidth aggregation server via different ones of a plurality of access points, each of the plurality of access points configured to communicate with the bandwidth aggregation server using a different network path, the client device comprising:
a computer readable medium having stored thereon instructions for client routing software;
a processor configured to execute the client routing software, the client routing software operable to:
segment the data to be transmitted into a plurality of data packets;
schedule the plurality of packets to be transmitted to the bandwidth aggregation server via a primary one of the plurality of access points; and
schedule the plurality of packets to be transmitted to the bandwidth aggregation server via a secondary one of the plurality of access points, should the primary access point fail; and
transceivers configured to transmit the plurality of data packets to corresponding access points for sending the data to the bandwidth aggregation server and receive data from the bandwidth aggregation server via the corresponding access points.

13. A bandwidth aggregation server configured to communicate with a client via different ones of a plurality of access points, each of the plurality of access points configured to communicate with the client using a different network path, the bandwidth aggregation server comprising:
a computer readable medium having stored thereon instructions for a server routing software;
a processor configured to execute the server routing software, the server routing software operable to:
segment the data to be transmitted into a plurality of data packets;
schedule the plurality of packets to be transmitted to the client via a primary one of the plurality of access points; and
schedule the plurality of packets to be transmitted to the client via a secondary one of the plurality of access points, should the primary access point fail; and
transceivers configured to transmit the plurality of data packets to corresponding access points for sending the data to the client and receive data from the client via the corresponding access points.
